(19) United States
(12) Patent Application Publication
(10) Pub. No.: US 2025/0124892 A1
(43) Pub. Date: Apr. 17, 2025

(54) METHODS AND APPARATUSES FOR MITIGATION OF MOTION SICKNESS

(71) Applicants: Maryam KEYVANARA, Toronto (CA); Szu Wen FAN, Markham (CA); Juntao YE, Markham (CA)

(72) Inventors: Maryam KEYVANARA, Toronto (CA); Szu Wen FAN, Markham (CA); Juntao YE, Markham (CA)

(21) Appl. No.: 18/487,501

(22) Filed: Oct. 16, 2023

(51) Int. Cl. G09G 5/00; G06F 3/01

(52) U.S. Cl. CPC G09G 5/003; G06F 3/013; G09G 2340/0407; G09G 2354/00; G09G 2380/10

(57) ABSTRACT

Methods and apparatuses for providing visual output to mitigate motion sickness are described. Sensed data representing vehicle motion and data for determining a point of focus on a display are obtained. A foveal region of the display and a peripheral region of the display are defined relative to the point of focus. A visual output is provided, via the display, with visual cues representing the vehicle motion, the visual cues being provided in the peripheral region and being excluded from the foveal region.

### CROSS-REFERENCE TO RELATED APPLICATIONS

This is the first application for this disclosure.

### FIELD

The present disclosure relates to mitigation of motion sickness, including carsickness, using visual cues that are dynamically provided on a display.

### BACKGROUND

Motion sickness is commonly understood to occur due to sensory conflict. For example, an individual's visual system (eyes) observes the environment and their vestibular system (inner ears) senses motion. If the sensory signals from these two systems do not match then the individual is more likely to develop motion sickness. A common scenario in which an individual may experience motion sickness is when watching a video on a handheld digital device (e.g., a tablet or a smartphone) while sitting in a moving vehicle such as a car or a boat. With advances in handheld devices and autonomous or semi-autonomous vehicles, the likelihood increases of an individual being engaged in watching a video or other visual task while in a moving vehicle. It would be useful to provide a solution to mitigate motion sickness in such scenarios.

### SUMMARY

In various examples, the present disclosure describes methods and apparatuses for providing visual output to help mitigate motion sickness. In particular, the visual output includes visual cues representing vehicle motion, where the visual cues are provided in a manner that avoids or reduces obstruction to a user's main visual activity. The visual cues may be provided in a peripheral region of the display, outside of a foveal region where a user's point of focus is determined to be located. The visual cues may be dynamically provided such that the location of the visual cues change as the location of the user's point of focus change. This provides the advantage that the user's main visual activity may be kept free of visual cues, even as the user's point of focus moves.

In some examples, foveated rendering may be used to provide the visual output. Using foveated rendering, visual output in the foveal region (which encompasses the user's point of focus) is provided with higher resolution than visual output outside of the foveal region. The visual cues representing vehicle motion may be displayed in the lower resolution peripheral region. This may help to reduce the use of computing resources (e.g., processing power) required to render the visual output.

In some examples, the present disclosure describes a method at an electronic device, the method including: obtaining sensed data representing vehicle motion; obtaining data for determining a point of focus on a display; defining a foveal region of the display and a peripheral region of the display, the foveal region and the peripheral region being defined relative to the point of focus; and providing a visual output, via the display, with visual cues representing the vehicle motion, the visual cues being provided in the peripheral region and being excluded from the foveal region.

In an example of the preceding example of the method, the data for determining the point of focus may be one of: data representing a location of a detected gaze on the display, wherein the point of focus is determined to be the location of the detected gaze on the display; data representing a salient region of an image to be outputted on the display, wherein the point of focus is determined based on a bounding box of the salient region; data representing a location of a touch input on the display, wherein the point of focus is determined to be the location of the touch input on the display; or data representing a location of a mouse input on the display, wherein the point of focus is determined to be the location of the mouse input on the display.

In an example of the preceding example of the method, the data for determining the point of focus may be data representing multiple salient regions of the image to be outputted on the display, and the point of focus may be determined based on the bounding box of the salient region having a highest saliency score or highest saliency ranking.

In an example of a preceding example of the method, the data for determining the point of focus may be data representing multiple salient regions of the image to be outputted on the display, and a respective multiple points of focus may be determined based on the respective multiple bounding boxes of the respective multiple salient regions.

In an example of any of the preceding examples of the method, the foveal region may be defined to be a region immediately surrounding and encompassing the point of focus, and the peripheral region may be defined to be a region outside of the foveal region and surrounding the foveal region.

In an example of any of the preceding examples of the method, providing the visual output may include providing the visual output with higher resolution in the foveal region and lower resolution outside of the foveal region.

In an example of the preceding example of the method, the visual output outside of the foveal region may have a resolution that progressively decreases with distance from the foveal region.

In an example of any of the preceding examples of the method, the visual cues may be provided in only a portion of the peripheral region.

In an example of any of the preceding examples of the method, the method may include: determining an updated point of focus at an updated location on the display; updating the foveal region and the peripheral region relative to the updated location of the updated point of focus; and providing an updated visual output, via the display, with the visual cues being provided in the updated peripheral region and being excluded from the updated foveal region.

In an example of the preceding example of the method, updating the foveal region and the peripheral region may include changing at least one of a size parameter, a shape parameter, or a centeredness parameter of at least one of the foveal region or the peripheral region.

In some examples, the present disclosure describes an electronic device including a processing unit coupled to a display, the processing unit being configured to execute computer-readable instructions to cause the electronic device to: obtain sensed data representing vehicle motion; obtain data for determining a point of focus on the display; define a foveal region of the display and a peripheral region of the display, the foveal region and the peripheral region being defined relative to the point of focus; and provide a visual output, via the display, with visual cues representing the vehicle motion, the visual cues being provided in the peripheral region and being excluded from the foveal region.

In an example of the preceding example of the electronic device, the data for determining the point of focus may be one of: data representing a location of a detected gaze on the display, wherein the point of focus is determined to be the location of the detected gaze on the display; data representing a salient region of an image to be outputted on the display, wherein the point of focus is determined based on a bounding box of the salient region; data representing a location of a touch input on the display, wherein the point of focus is determined to be the location of the touch input on the display; or data representing a location of a mouse input on the display, wherein the point of focus is determined to be the location of the mouse input on the display.

In an example of the preceding example of the electronic device, the data for determining the point of focus may be data representing multiple salient regions of the image to be outputted on the display, and the point of focus may be determined based on the bounding box of the salient region having a highest saliency score or highest saliency ranking.

In an example of a preceding example of the electronic device, the data for determining the point of focus may be data representing multiple salient regions of the image to be outputted on the display, and a respective multiple points of focus may be determined based on the respective multiple bounding boxes of the respective multiple salient regions.

In an example of any of the preceding examples of the electronic device, the foveal region may be defined to be a region immediately surrounding and encompassing the point of focus, and the peripheral region may be defined to be a region outside of the foveal region and surrounding the foveal region.

In an example of any of the preceding examples of the electronic device, providing the visual output may include providing the visual output with higher resolution in the foveal region and lower resolution outside of the foveal region.

In an example of the preceding example of the electronic device, the visual output outside of the foveal region may have a resolution that progressively decreases with distance from the foveal region.

In an example of any of the preceding examples of the electronic device, the instructions may further cause the electronic device to: determine an updated point of focus at an updated location on the display; update the foveal region and the peripheral region relative to the updated location of the updated point of focus; and provide an updated visual output, via the display, with the visual cues being provided in the updated peripheral region and being excluded from the updated foveal region.

In an example of any of the preceding examples of the electronic device, the electronic device may be one of: a smartphone; a laptop; a tablet; an in-vehicle display device; a head mounted display device; an augmented reality device; or a virtual reality device.

In an example of any of the preceding examples of the electronic device, the instructions may further cause the electronic device to perform any of the preceding examples of the method.

In some examples, the present disclosure provides a computer-readable medium having machine-executable instructions stored thereon, the instructions, when executed by a processing unit of an electronic device, cause the electronic device to: obtain sensed data representing vehicle motion; obtain data for determining a point of focus on the display; define a foveal region of the display and a peripheral region of the display, the foveal region and the peripheral region being defined relative to the point of focus; and provide a visual output, via the display, with visual cues representing the vehicle motion, the visual cues being provided in the peripheral region and being excluded from the foveal region.

In an example of the preceding example of the computer-readable medium, the instructions may further cause the electronic device to perform any of the preceding examples of the method.

In some example aspects, the present disclosure describes a computer program comprising instructions which, when the program is executed by an electronic device, cause the electronic device to carry out any of the above examples of the method.

### BRIEF DESCRIPTION OF THE DRAWINGS

Reference will now be made, by way of example, to the accompanying drawings which show example embodiments of the present application, and in which:

FIG. 1 is a block diagram illustrating a user interacting with an example electronic device in a vehicle, in accordance with examples of the present disclosure;

FIG. 2 is a block diagram illustrating some components of an example electronic device, in accordance with examples of the present disclosure;

FIG. 3 illustrates an example of a dynamic foveal region and peripheral region, in accordance with examples of the present disclosure;

FIG. 4 is a block diagram illustrating some details of an example visual cues renderer that may be implemented in an example electronic device, in accordance with examples of the present disclosure; and

FIG. 5 is a flowchart illustrating an example method for providing visual cues representing vehicle motion, in accordance with examples of the present disclosure.

Similar reference numerals may have been used in different figures to denote similar components.

### DETAILED DESCRIPTION

In various examples, the present disclosure describes methods and apparatuses for mitigation of motion sickness (in particular, motion sickness caused by vehicle motion, such as carsickness) using dynamic rendering of motion cues on a display of an electronic device. Dynamic rendering, in the present disclosure, may refer to rendering of visual output that is adaptive to the user, in contrast with static rendering in which visual output is rendered in a fixed location, fixed shape and/or fixed size. As will be discussed further below, motion cues (which may include, arrows, moving patterns, motion blur, etc.) may be rendered to reflect motion of a vehicle. The motion cues may be rendered using foveated rendering, which may adapt to a user's visual focus (e.g., detected using gaze tracking, touch tracking, mouse tracking, head tracking, etc.).

In the present disclosure, an electronic device may be any device that has a display, including a television (e.g., smart television), a mobile communication device (e.g., smartphone), a tablet device, a vehicle-based device (e.g., an infotainment system or an interactive dashboard device), a wearable device (e.g., smartglasses, smartwatch or head mounted display (HMD)) or an Internet of Things (IoT) device, among other possibilities. The electronic device may be an in-vehicle device (e.g., already built into the vehicle, such as a dashboard device) or may be a portable or mobile device that a user may use while in the vehicle.

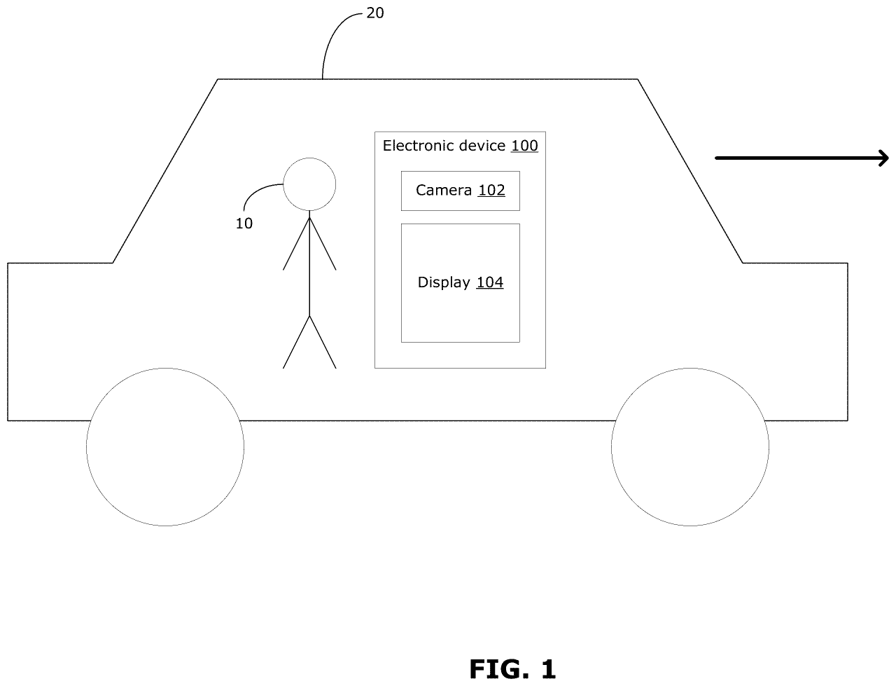

FIG. 1 shows an example of a user 10 using an electronic device 100 while in a vehicle 20. The vehicle 20 is moving (indicated by arrow) while the user 10 and the electronic device 100 are inside the vehicle 20. In this simplified diagram, the electronic device 100 includes a camera 102 that may capture the user's eyes, for the purpose of gaze tracking for example. In other examples, the electronic device 100 may not perform gaze tracking, as will be discussed further below. The electronic device 100 also includes a display 104 providing a visual output, such as a video, static image, graphical user interface (GUI), game, etc. Visual output from the electronic device 100 is sensed by the visual system (e.g., eyes) of the user 10 while motion from the vehicle 20 is sensed by the vestibular system (e.g., inner ears) of the user 10. When the apparent motion perceived by the visual system (e.g., relative lack of motion in a watched video) conflicts with the actual motion sensed by the vestibular system (e.g., motion of the vehicle 20), the user 10 may experience motion sickness.

Some existing attempts to mitigate motion sickness include approaches that provide visual indicators of estimated vehicle motion, such as displaying floating bubbles in the margins of a text being read by a user, displaying dots showing a vehicle's rotation, displaying optical flow particles over a viewing content, or showing the outside environment in a margin below a text. Some existing solutions address a particular application, such as in virtual reality (VR) or augmented reality (AR) applications, and may not be readily adapted or applicable to other scenarios (e.g., motion sickness due to vehicle motion).

A drawback of existing solutions is that they are typically obtrusive for the user's main visual activity (e.g., watching a video, reading a text, playing a game, etc.). In existing solutions, the main visual task typically has to be reduced in size to create margins in which visual cues can be added to show vehicle motion, or the visual cues may be shown in the user's central field of view. Such solutions may distract from the user's main visual activity.

Another drawback of existing solutions is that the visual indicators are static in their placement, and typically fixed on screen (e.g., always shown in the margins). This means that when a user's eyes scan different parts of the display, the visual indicators may appear in the user's foveal vision (i.e., the in-focus, central portion of a person's view), hence interfering with the user's main visual activity.

In various examples, the present disclosure describes methods and apparatuses for mitigation of motion sickness, particularly motion sickness due to a user being engaged in a visual activity (e.g., watching video, reading a text, looking at a static image, interacting with a GUI, etc.) while in a moving vehicle (e.g., car, boat, train, etc.). Examples of the present disclosure provide visual cues representing vehicle motion that do not distract from the user's main visual activity. Visual cues representing vehicle motion may be dynamically rendered such that the visual cues are maintained in the user's peripheral vision (rather than the user's foveal vision). Generally, humans have a high sense of motion detection in their peripheral vision. Thus visual cues rendered in the user's peripheral vision may provide visual information about the vehicle's current motion to help mitigate motion sickness, while being rendered in a manner that does not obstruct the main visual activity (which is in the user's foveal vision).

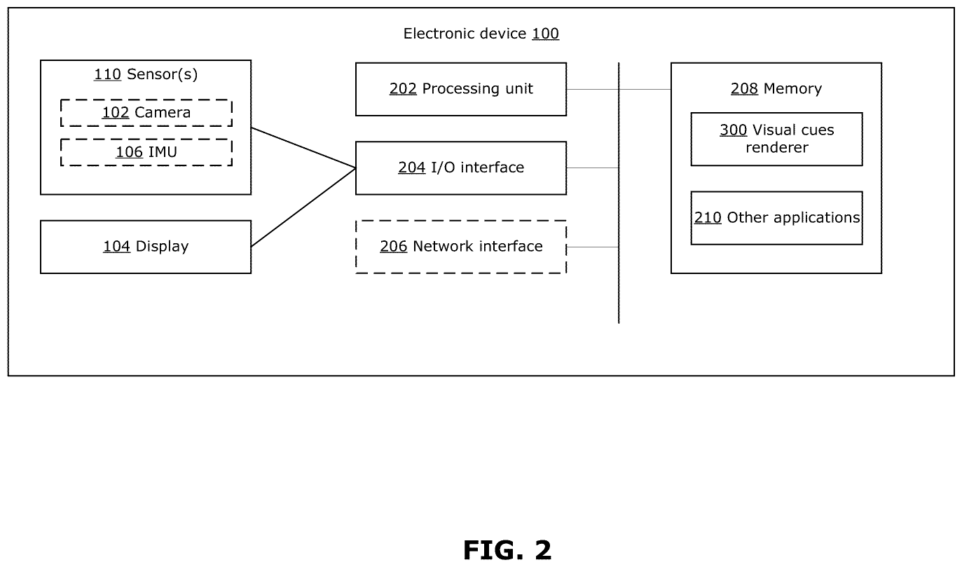

FIG. 2 is a block diagram showing some components of an example electronic device 100 (which may also be referred to generally as an apparatus), which may be used to implement embodiments of the present disclosure. Although an example embodiment of the electronic device 100 is shown and discussed below, other embodiments may be used to implement examples disclosed herein, which may include components different from those shown. Although FIG. 2 shows a single instance of each component, there may be multiple instances of each component shown.

The electronic device 100 includes one or more processing units 202, such as a processor, a microprocessor, an application-specific integrated circuit (ASIC), a field-programmable gate array (FPGA), a dedicated logic circuitry, a dedicated artificial intelligence processor unit, or combinations thereof. The electronic device 100 also includes one or more input/output (I/O) interfaces 204, which interfaces with input devices including one or more sensors 110 such as a camera 102 and/or an inertial measurement unit (IMU) 106. The I/O interface may also interface with output devices such as the display 104. The electronic device 100 may include other input devices (e.g., buttons, microphone, touchscreen, keyboard, etc.) and other output devices (e.g., speaker, vibration unit, etc.).

The electronic device 100 may include one or more optional network interfaces 206 for wired or wireless communication with a network (e.g., an intranet, the Internet, a P2P network, a WAN and/or a LAN) or other node. The network interface(s) 206 may include wired links (e.g., Ethernet cable) and/or wireless links (e.g., one or more antennas) for intra-network and/or inter-network communications. In some examples, the network interface 206 may enable the electronic device 100 to communicate with the vehicle 20 (e.g., to receive vehicle data from the controller area network (CAN bus) or from on-board diagnostics (OBD)).

The electronic device 100 includes one or more memories 208, which may include a volatile or non-volatile memory (e.g., a flash memory, a random access memory (RAM), and/or a read-only memory (ROM)). The non-transitory memory(ies) 208 may store instructions for execution by the processing unit(s) 202, such as to carry out examples described in the present disclosure. For example, the memory(ies) 208 may include instructions, executable by the processing unit(s) 202, to implement a visual cues renderer 300 that provides visual cues representing vehicle motion, as discussed further below. The memory(ies) 208 may include other software instructions 210, such as for implementing an operating system and other applications/functions. For example, the memory(ies) 208 may include software instructions 210 for providing a main visual activity, such as playing a video, displaying a text, etc.

In some examples, the electronic device 100 may also include one or more electronic storage units (not shown), such as a solid state drive, a hard disk drive, a magnetic disk drive and/or an optical disk drive. In some examples, one or more data sets and/or modules may be provided by an external memory (e.g., an external drive in wired or wireless communication with the electronic device 100) or may be provided by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage. The components of the electronic device 100 may communicate with each other via a bus, for example.

As will be discussed further below, the electronic device 100 may provide visual cues representing real-time (or near real-time) vehicle motion, where the visual cues are dynamically rendered to be in the user's peripheral vision rather than being fixed. In this way, a user in a moving vehicle can visually sense and be aware of the vehicle motion (thus helping to mitigate motion sickness), while the main visual activity is not obstructed.

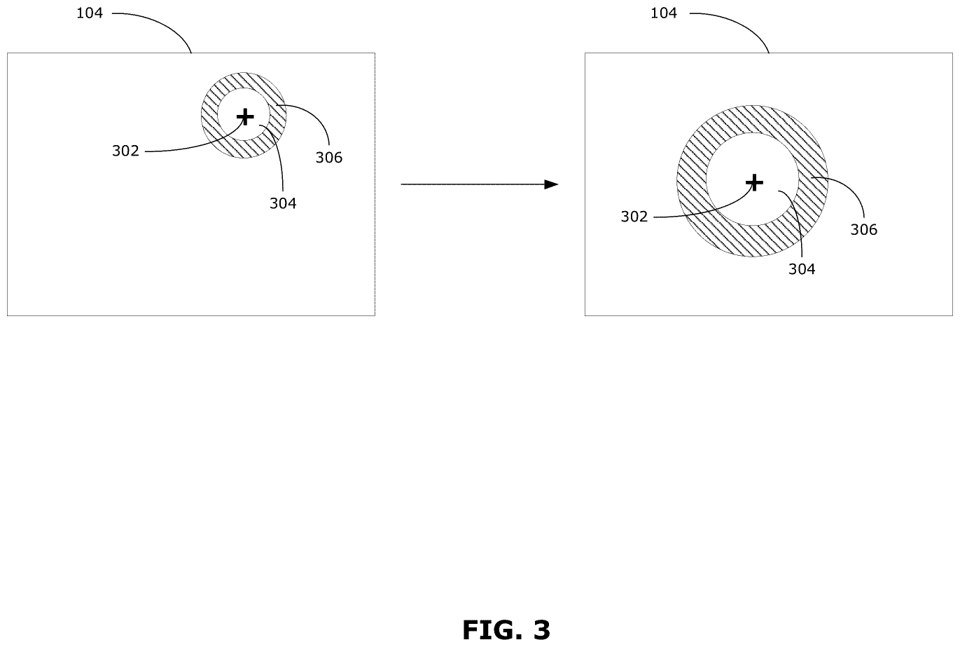

FIG. 3 illustrates an example of how visual cues may be dynamically rendered in the user's peripheral vision.

As shown on the left side of FIG. 3, the display 104 may be providing visual output (e.g., playing a video, displaying a photo, showing a text, etc.). A user's point of focus 302 may be determined using, for example, gaze tracking, head tracking, tracking of touch inputs, tracking of mouse inputs, etc. In some examples, the point of focus 302 may be determined based on saliency of the visual output. For example, a trained neural network may be used to predict the most salient region(s) of an image to be outputted (e.g., main foreground object in a video or photo, foreground object closest to the center of an image, etc.), and the salient region(s) may be determined to be point(s) of focus 302. Thus, in some examples there may be multiple points of focus 302. For simplicity, the example where there is a single point of focus 302 is discussed below. However, it should be understood that the following description with respect to a single point of focus 302 may be readily adapted to multiple points of focus 302 (e.g., where there is a respective foveal region and a respective peripheral region defined for each point of focus).

A foveal region 304 (also referred to as the central region or in-focus region) is defined as the region immediately surrounding (and encompassing) the point of focus 302. A peripheral region 306 (also referred to as the non-focus region) is defined as the region that is outside of and typically surrounding the foveal region 304 (but does not necessarily extend to the edges of the display 104). For example, the peripheral region 306 may be defined as a band (of even or uneven width) surrounding the foveal region 304. In the present disclosure, the term foveal region may be used to refer to a region of a user's view immediately surrounding (and encompassing) the visual point of focus, and the term peripheral region may be used to refer to a region of a user's view surrounding the foveal region; the terms foveal region (or foveal vision) and peripheral region (or peripheral vision) may not be strictly limited by the anatomical or medical usage of these terms. For example, the terms foveal region and peripheral region, as used herein, may be replaced by the terms: central region and peripheral region; in-focus region and non-focus region; or first region and second region.

Visual cues (indicated by shading in FIG. 3) representing the vehicle's motion may be rendered in the peripheral region 306. The visual cues representing the vehicle's motion may be excluded from the foveal region 304. The visual cues may be, for example, moving arrows, motion blur, optical particle flow, moving patterns, etc. The visual cues may have a direction of movement, speed of movement and/or density based on the detected vehicle motion. The vehicle motion may be detected by one or more sensors 110 of the electronic device 100 (e.g., the IMU 106). Alternatively or additionally, the vehicle motion may be detected from CAN bus data communicated to the electronic device 100 from the vehicle's on-board sensors.

The visual cues may be provided throughout the peripheral region 306, as illustrated in FIG. 3. In other examples, the visual cues representing vehicle motion may be provided in only a portion of the peripheral region 306, for example only in the portion of the peripheral region 306 that is farther away from the foveal region 304, such that the portion of the peripheral region 306 that immediately abuts the foveal region 304 is free of visual cues. In yet other examples, the visual cues representing vehicle motion may be provided in only an upper portion, only a lower portion, only a left-side portion or only a right-side portion of the peripheral region 306. Other such variations may be possible within the scope of the present disclosure. The portion of the peripheral region 306 that displays visual cues may be adjustable (e.g., manually adjustable).

On the right side of FIG. 3, the user's point of focus 302 has moved downwards and to the left. Accordingly, the location of the foveal region 304 is updated so that the foveal region 304 remains immediately surrounding the point of focus 302, and the location of the peripheral region 306 is similarly updated to remain surrounding the foveal region 304. Further, the sizes of the foveal region 304 and peripheral region 306 are larger (e.g., the size parameter of the foveal region 304 and peripheral region 306 may have been increased due to a change in the user's distance from the display 104). The visual cues (indicated by shading in FIG. 3) representing the vehicle's motion may continue to be rendered in the updated peripheral region 306. In this way, visual cues representing vehicle motion may be rendered dynamically, based on the location of a determined visual focus of the user.

In the example of FIG. 3, the foveal region 304 is defined as a circular region centered on the point of focus 302 and having a first radius, and the peripheral region 306 is defined as an annular region having an outer radius larger than the first radius and having an inner radius equal to the first radius. However, it should be understood that the shape of the foveal region 304 and peripheral region 306 need not be limited to circular shapes, and further the foveal region 304 and peripheral region 306 need not have the same or similar geometry. For example, the foveal region 304 may be an elliptical region and the peripheral region 306 may be a larger elliptical region or larger circular region that excludes the foveal region 304. Further, although FIG. 3 shows the foveal region 304 and peripheral region 306 both centered on the point of focus 302, this is not intended to be limiting. For example, if the point of focus 302 is moving, the foveal region 304 and peripheral region 306 may be defined to be centered on a location slightly ahead of the point of focus 302 in the direction of movement.

As illustrated in FIG. 3, visual cues representing vehicle motion may be dynamically rendered in a peripheral region that is dynamically updated based on the determined point of focus (e.g., dynamically updated based on the dynamic location of the point of focus). Further, various parameters of the dynamic rendering of visual cues may be adjusted. For example, the size of the foveal region 302 and/or peripheral region 304 may be adjusted; the ratio between the size of the foveal region 302 and the size of the peripheral region 304 may be adjusted; the centeredness (with respect to the point of focus 302) of the foveal region 302 and/or peripheral region 304 may be adjusted; the shape of the foveal region 302 and/or peripheral region 304 may be adjusted; and/or the density and shape of visual cues may be adjusted; among other possibilities. Thus, the foveal region 302 and/or peripheral region 304 may be adaptive, for example their sizes may dynamically adjust based on variables such as the distance between the user and the display 104 (which may be sensed by proximity sensors of the electronic device 100), dimensions of the display 104, etc.

The examples of the present disclosure aim to render visual cues representing vehicle motion in a user's peripheral vision, while aiming to keep the foveal vision unobstructed. In typical human vision, foveal vision has a higher visual acuity, color perception and contrast sensitivity, and peripheral vision has better motion perception and detection of changes. Thus, the display of visual cues representing vehicle motion in the peripheral region may enable the user to continue with their main visual activity while also enabling the user to perceive vehicle motion, which may help to reduce motion sickness.

In some examples, in addition to providing visual cues representing vehicle motion, foveated rendering may be used. By foveated rendering, it is meant that visual output in the foveal region is provided at a higher resolution than visual output outside of the foveal region (which may include visual output in the peripheral region as well as visual output in the remainder of the display outside of the peripheral region). This may help to save computational resources, for example by reducing processing power required to render the output. In some examples, foveated rendering may be implemented by displaying visual output in the foveal region using a resolution that is normally provided by the display, and a lower resolution (lower than the normal resolution of the display) outside the foveal region. In some examples, the resolution of the visual output may gradually or progressively decrease with distance from the foveal region.

It should be understood that the display of visual cues representing vehicle motion in the peripheral region may be provided with or without foveated rendering. Further, visual cues may be displayed in a portion (or all) of the peripheral region independently of a lower resolution being used in the same or different portion (or all) of the peripheral region.

Visual cues representing vehicle motion (e.g., as illustrated in FIG. 3) may be generated using the visual cues renderer 300 of the electronic device 100. Details of an example visual cues renderer 300 are now provided.

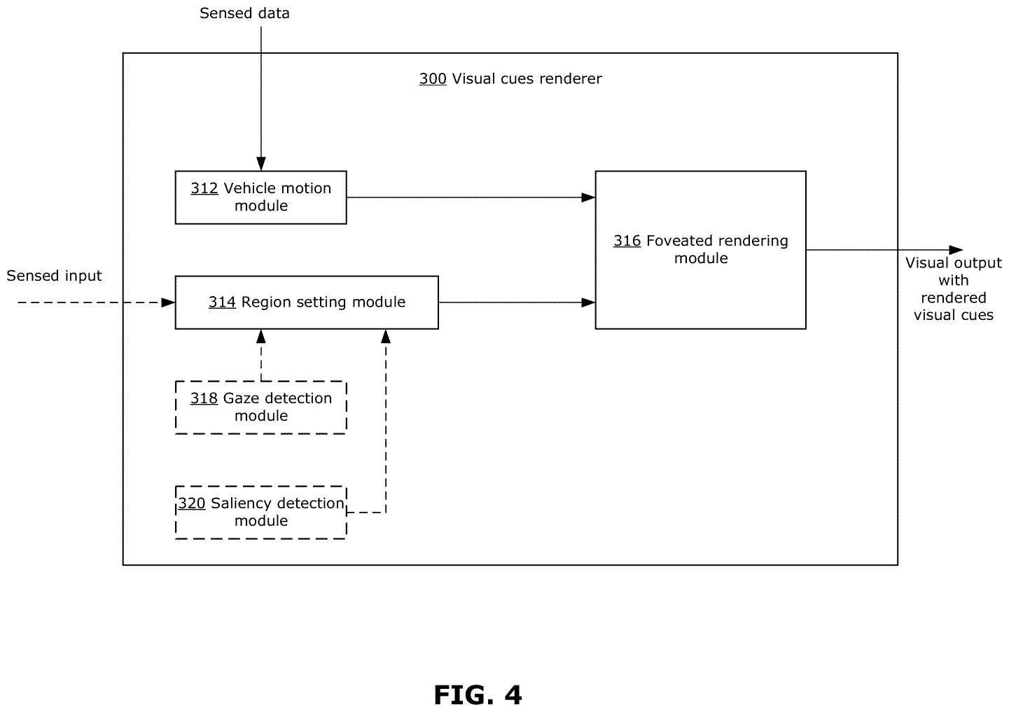

FIG. 4 is a block diagram showing some components of an example visual cues renderer 300, which may be used to implement embodiments of the present disclosure. Although the visual cues renderer 300 is illustrated as having certain subsystems, it should be understood that this is not intended to be limiting. For example, the visual cues renderer 300 may be implemented using greater or fewer numbers of modules, or may not require any modules (e.g., functions described as being performed by certain modules may be performed by the overall visual cues renderer 300). Further, functions described herein as being performed by a particular module may instead be performed by another module. Generally, the functions of the visual cues renderer 300, as described herein, may be implemented in various suitable ways within the scope of the present disclosure.

In this example, the visual cues renderer 300 includes a vehicle motion module 312, a region setting module 314, a foveated rendering module 316, an optional gaze detection module 318 and an optional saliency detection module 320.

The vehicle motion module 312 receives sensed data (e.g., from the IMU 106 of the electronic device 100 and/or from the CAN bus of the vehicle 20) that represent motion of the vehicle 20. For example, the sensed data may include acceleration data, velocity data, angular acceleration data, angular velocity data, etc. The vehicle motion module 312 processes the sensed data to generate visual cues representing the vehicle motion. For example, the vehicle motion module 312 may generate moving patterns, moving arrows or motion blur corresponding to the direction, speed and acceleration of the vehicle motion. The generated visual cues may be provided to the foveated rendering module 316.

The region setting module 314 receives information determining a point of focus (or multiple points of focus) and defines the foveal region and peripheral region for each point of focus. The region setting module 314, for example, may receive information representing a sensed input (e.g., sensed touch input or sensed mouse input), may receive information representing a detected gaze (e.g., from the optional gaze detection module 318 or from an external module (not shown)) and/or may receive information representing a salient region (e.g., a bounding box for at least one salient region of a current frame of image data may be received from the optional saliency detection module 320 or from an external module (not shown)). The region setting module 314 may define various parameters of the foveal region and peripheral region, such as shape, size, centeredness, etc. The region setting module 314 may also define the locations of the foveal region and peripheral region (e.g., centered on the corresponding point of focus).

The visual cues from the vehicle motion module 312 and the defined foveal region and defined peripheral region from the region setting module 314 are received by the foveated rendering module 316. Based on the defined foveal region and defined peripheral region, the foveated rendering module 316 may render the visual output (e.g., video being played, image being viewed, GUI being displayed, etc.) such that the foveal region has higher resolution than the visual output outside of the foveal region. In some examples, the resolution may progressively decrease with distance from the foveal region. In other examples, a first higher resolution may be used in the foveal region and a second lower resolution may be used outside of the foveal region. In yet other examples, a first higher resolution may be used in the foveal region, a second intermediate resolution may be used in the peripheral region or the resolution in the peripheral region may gradually transition from the higher resolution to a lower resolution, and a third lower resolution may be used in the remainder of the display. Other such variations may be possible within the scope of the present disclosure. The foveated rendering module 316 also overlays the visual cues representing vehicle motion in the peripheral region.

The visual output (e.g., a current frame of a video being played, a current static image being viewed, a current display of a GUI, etc.) with rendered visual cues may then be outputted by the visual cues renderer 300 to be displayed by the display 104 of the electronic device 100. In some examples, the visual cues renderer 300 may provide the rendered visual cues, located in the defined peripheral region, as an overlay to be applied to the visual output, and another application (not shown) may provide the visual output with the overlay. For example, if the user's visual activity is watching a video, then the visual cues renderer 300 may provide the visual cues as an overlay to be applied by a video player application. In other examples, the visual cues renderer 300 may be a system-level module that is used to process visual output from various applications prior to being displayed. For example, video frames from a video player application may be first processed by the visual cues renderer 300, to apply visual cues and foveated rendering, and then the output from the visual cues renderer 300 is provided to the display 104.

In some examples, depending on the implementation, the gaze detection module 318 and/or the saliency detection module 320 may be omitted from the visual cues renderer 300. For example, gaze detection may not be required in some embodiments (e.g., the user's point of focus may be determined based on saliency instead, or based on touch or mouse input instead) and the gaze detection module 318 may be omitted. In another example, saliency detection may not be required in some embodiments (e.g., the user's point of focus may be determined based on gaze detection instead, or based on touch or mouse input instead) and the saliency detection module 320 may be omitted. In yet other examples, the functions of the gaze detection module 318 and/or saliency detection module 320 may be performed external of the visual cues renderer 300. For example, a separate and external gaze detection system may detect the user's gaze and provide the location of the user's gaze to the visual cues renderer 300 as a point of focus. In another example, a separate an external saliency detection system may detect salient region(s) and provide the bounding box(es) of the salient region(s) to the visual cues renderer 300 as point(s) of focus.

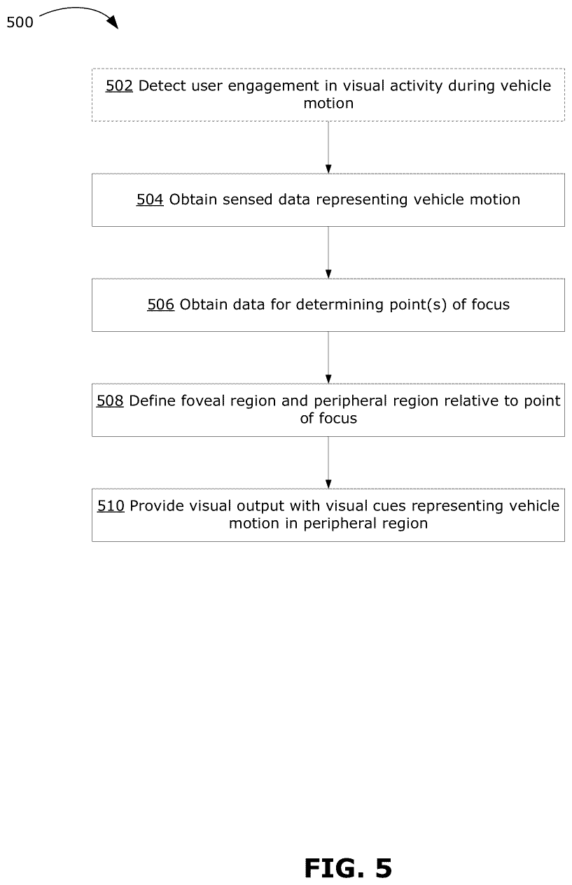

FIG. 5 is a flowchart illustrating an example method 500 for providing visual output with visual cues representing vehicle motion. It should be understood that the visual cues are dynamic visual cues, meaning the region displaying the visual cues may change in shape, size and/or location, and as well the visual cues may change in direction, speed and/or density (e.g., to reflect real-time or near real-time vehicle motion). In examples where foveated rendering is used (where the resolution of the visual output in the foveal region is higher than resolution outside of the foveal region), the visual cues may be referred to as foveated visual cues. The method 500 may be implemented by the electronic device 100 using the visual cues renderer 300 (e.g., by the processing unit 202 executing instructions stored in the memory 208, to implement the visual cues controller 300). In general, the method 500 may be performed by any suitable electronic device for providing visual output via a display.

Optionally, at 502, the electronic device 100 may detect user engagement in a visual activity during vehicle motion. For example, the electronic device 100 may detect that an application with visual output (e.g., a video player application, a photo manager application, an e-reader application, etc.) is being executed while motion is detected (e.g., detected by the IMU 106 or motion data is received from the CAN bus of the vehicle 20). If user engagement in a visual activity is detected during vehicle motion, the electronic device 100 may activate the visual cues renderer 300 and perform the method 500.

In some examples, the visual cues renderer 300 may be manually activated (e.g., the user may activate a “motion sickness mode” on the electronic device 100).

At 504, sensed data representing vehicle motion is obtained. The sensed data may be obtained from the IMU 106 of the electronic device 100 and/or via the CAN bus of the vehicle 20, for example. The sensed data may include velocity data, angular velocity data, acceleration data, angular acceleration data, orientation data, etc. The sensed data may be used (e.g., by the vehicle motion module 312 of FIG. 4) for generating visual cues representing vehicle motion.

At 506, data for determining at least one point of focus on the display is obtained. For example, input data may be a detected location of the user's gaze on the display, may be a predicted salient region of an image (e.g., a frame of video, a static image, etc.) to be shown on the display, may be a detected location of mouse input on the display or may be a detected location of touch input on the display.

In examples where the point of focus is a detected location of the user's gaze, an eye tracking or gaze detection module (e.g., the gaze detection module 318 of FIG. 4) may be used. For example, the electronic device 100 (which may be a wearable VR/AR headset, a tablet, a smartphone, etc.) may have an integrated gaze detection function. A camera 102 of the electronic device 100 may capture live frames of the user and detect the eyes of the user in the live frames. A gaze detection algorithm (which may be implemented using a gaze detection neural network) may estimate the gaze vector and/or the location of the user's gaze on the display 104. The data for determining the point of focus may be the coordinates of the location of the estimated user's gaze on the display 104, and the point of focus may be determined based on the coordinates.

In examples where the point of focus is a predicted salient region of an image to be outputted as visual output, a trained neural network may be used to implement a saliency detection module (e.g., the saliency detection module 320 of FIG. 4). The saliency detection module may detect one or more highest saliency regions of the visual output. The saliency detection module may output the bounding box (or other location indicator) of each detected salient region, and optionally may include a saliency score or saliency ranking with each detected salient region. In some examples only one most salient region (e.g., the salient region with highest saliency score or highest saliency ranking) may be determined to be the point of focus. In other examples, there may be multiple points of focus corresponding to multiple highly salient regions (e.g., top five salient regions).

In examples where the point of focus is a detected location of a mouse input or touch input (which may be detected based on the input capabilities of the electronic device 100), the location of mouse input or touch input may be received (e.g., via the I/O interface 204 of the electronic device 100) as a coordinate location on the display 104. The point of focus may be determined based on the coordinates.

It should be understood that different types of data may be used to determine the user's point(s) of focus, such as head tracking, in addition to those discussed above. In some examples, head tracking may be used to assist gaze detection for determining a point of focus on the display. For example, when gaze detection is unable to determine eye gaze (e.g., the user's eyes are obstructed by sunglasses), head tracking may be used to determine the position and angle of the user's head, which may be used to determine a location of the point of focus on the display.

At 508, a foveal region and a peripheral region are defined relative to each point of focus. In some examples, step 508 may be performed using the region setting module 314 of FIG. 4. The foveal region may be defined as a region of the display surrounding a determined point of focus, and the peripheral region may be defined as a region of the display outside of the foveal region. The peripheral region may, in some examples, encompass all of the display excluding the foveal region(s). In other examples, the peripheral region may be a region that forms a band or margin surrounding the foveal region. Notably, the locations of the foveal region and peripheral region are defined relative to the location of the determined point of focus. For example, the foveal region and peripheral region may be centered on the point of focus and may move as the determined location of the point of focus moves (e.g., corresponding to movement of the detected gaze, movement of a touch or mouse input, or change in the detected salient region(s)). As previously discussed, parameters of the foveal region and/or the peripheral region may also be adjustable and may include, for example, the shape, size (e.g., length of radius if the shape is circular or elliptical), centeredness, etc. The parameters may also dynamically change.

In some examples, if the determined point of focus is based on a coordinate location of the display (e.g., based on a coordinate location of a detected gaze, based on a coordinate location of a touch input or based on a coordinate location of a mouse input), then the foveal region and the peripheral region may be defined relative to the coordinate location. For example, the location of the point of focus may be used as the center of the foveal region and the center of the peripheral region; or the center of the foveal region and the center of the peripheral region may be defined to be offset a certain distance relative to the location of the point of focus.

In some examples, if the determined point of focus is based on a salient region, the foveal region may be defined to be equal to the bounding box of the salient region. The peripheral region may then be defined as a band or margin around the foveal region. Alternatively, if the determined point of focus is based on a salient region, the foveal region and the peripheral region may be defined as a shape (e.g., circular region, elliptical region, square region, etc.) centered on the center of the bounding box of the salient region.

In some examples, if there are multiple points of focus determined (e.g., a few most salient regions are determined to be points of focus), there may be multiple foveal regions and multiple peripheral regions defined. Specifically, there may be one foveal region and one peripheral region defined for each of the multiple points of focus, where the foveal region and peripheral region for each point of focus may be defined as described above.

At 510, visual output is provided with visual cues representing vehicle motion, where the visual cues are provided in the peripheral region. Providing the visual output may include generating the visual cues representing vehicle motion, which may then be overlaid on a current visual output (e.g., a current frame of a video or a currently displayed image).

Visual cues representing vehicle motion may be generated (e.g., by the vehicle motion module 312 of FIG. 4) based on the obtained sensed data. For example, the direction of the visual cues (e.g., direction of motion blur, direction of arrows, direction of moving pattern, etc.) may be based on the direction of vehicle motion indicated by the sensed data. The speed and acceleration of the visual cues (e.g., speed of motion blur, speed of arrow movement, speed of moving pattern, etc.) may be based on the speed of vehicle motion indicated by the sensed data. The intensity or density of the visual cues may also be based on the speed of vehicle motion and/or may be adjusted according to the user's preference. For example, during acceleration or deceleration of the vehicle, the intensity or density of the visual cues may increase accordingly. Conversely, when the vehicle is moving at a relatively constant speed (such that acceleration or deceleration is low), the visual cues may be displayed with lower density or intensity. In some examples, when acceleration or deceleration is very low or near zero (i.e., the vehicle is moving at a substantially constant speed), the visual cues may not be displayed as the user may not experience motion sickness during constant (or near-constant) velocity vehicle movements.

The visual output may be provided with foveated rendering, in which visual output within the foveal region has a higher resolution than visual output outside of the foveal region. The visual cues may then be overlaid in the peripheral region, which has lower resolution than the foveal region.

In some examples, if there is a ranking of the multiple points of focus (e.g., if the multiple points of focus correspond to multiple salient regions that can be ranked by saliency score or that have saliency rankings), the foveal region corresponding to the highest ranked point of focus may have the highest resolution. For example, the foveal region corresponding to the most salient region (e.g., having highest saliency score) may be rendered at the highest resolution, and visual cues representing real-time vehicle motion may be overlaid in the peripheral region defined around that foveal region. The foveal region corresponding to lower-saliency regions may not be provided with visual cues representing vehicle motion.

The method 500 may be performed repeatedly to provide visual output together with visual cues representing real-time or near real-time vehicle motion. For example, an updated point of focus may be determined (e.g., at the next time step) to be at an updated location on the display. The foveal region and peripheral region may be updated relative to the updated location of the point of focus (e.g., if the foveal region and peripheral region are defined to be centered on the point of focus, the foveal region and peripheral region may be updated so that they are centered on the updated location of the point of focus). Then the visual output is provided with the visual cues in the updated peripheral region (and excluded from the updated foveal region).

The visual cues may be thus updated in real-time or near real-time to reflect the sensed data representing vehicle motion. Additionally, the location of the peripheral region where the visual cues are displayed may be updated as the location of the point of focus changes (e.g., as the detected location of the user's gaze changes; as the detected salient region(s) change; or as the detected location or mouse or touch input changes). Thus, the present disclosure describes examples that provide visual cues to help mitigate motion sickness, where the visual cues are displayed dynamically (e.g., not in a fixed location).

In an example implementation, the method 500 may be performed in a scenario where the user is riding in a moving car and is using an in-vehicle display to watch a video. In this case, at or shortly following the start of video playback on the in-vehicle display the method 500 may begin (e.g., activation of a “motion sickness mode”). Sensed data representing vehicle motion (e.g., data representing vehicle speed, acceleration, orientation, etc.) may be collected from sensors (e.g., OBD, CAN bus and/or IMU). As well, the user's current gaze may be detected and used to define the foveal and peripheral regions (the locations of which are continuously updated as the user's detected gaze moves). Visual cues representing the vehicle motion are displayed in real-time or near real-time in the peripheral region. In this way, the user is provided with visual cues about the vehicle's movements (e.g., turns, speed, etc.) which may help to ensure their visual and vestibular inputs are in agreement (thus helping to mitigate motion sickness), without compromising their viewing content or interfering with their main visual task.

It should be understood that the present disclosure may encompass other variations based on, for example, capabilities of the electronic device. For example, if the electronic device is capable of sensing depth (e.g., includes depth sensors) between the user and the display, the sensed depth data may be used to adjust parameters of the foveal region, parameters of the peripheral region and/or parameters of the visual cues.

In various examples, the present disclosure has described methods and apparatuses that provide visual cues representing vehicle motion in a manner that does not obstruct a user's main visual activity. The visual cues may be displayed in the peripheral region of a user's visual point of focus, and may change location dynamically as the user's visual point of focus moves. This may enable mitigation of motion sickness while avoiding intrusion into the user's main visual activity.

In some examples, the visual cues representing vehicle motion may be rendered according to adjustable parameters (which may be automatically adjustable and/or manually adjustable). For example, the size, shape and/or centeredness of the foveal region and peripheral region may be adjustable. As well, the density, shape and/or intensity of the visual cues may be adjustable. This may enable better customization to a user's particular situation (e.g., distance from the display screen to the user's eyes, size of the display screen, user's personal preferences, etc.).

Examples of the present disclosure may be implemented by various apparatuses, including mobile devices with displays (e.g., smartphones, laptops, tablets, etc.), wearable display devices (e.g., head mounted display device, AR/VR glasses, etc.) and in-vehicle display devices (e.g., dashboard displays, etc.), among others.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable an electronic device to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A method at an electronic device, the method comprising:
obtaining sensed data representing vehicle motion;
obtaining data for determining a point of focus on a display;
defining a foveal region of the display and a peripheral region of the display, the foveal region and the peripheral region being defined relative to the point of focus; and
providing a visual output, via the display, with visual cues that exhibit movement in accordance with the vehicle motion, the visual cues being provided in the peripheral region and being excluded from the foveal region.

2. The method of claim 1, wherein the data for determining the point of focus is one of:
data representing a location of a detected gaze on the display, wherein the point of focus is determined to be the location of the detected gaze on the display;
data representing a salient region of an image to be outputted on the display, wherein the point of focus is determined based on a bounding box of the salient region;
data representing a location of a touch input on the display, wherein the point of focus is determined to be the location of the touch input on the display; or
data representing a location of a mouse input on the display, wherein the point of focus is determined to be the location of the mouse input on the display.

3. The method of claim 2, wherein the data for determining the point of focus is data representing multiple salient regions of the image to be outputted on the display, wherein the point of focus is determined based on the bounding box of the salient region having a highest saliency score or highest saliency ranking.

4. The method of claim 2, wherein the data for determining the point of focus is data representing multiple salient regions of the image to be outputted on the display, wherein a respective multiple points of focus are determined based on the respective multiple bounding boxes of the respective multiple salient regions.

5. The method of claim 1, wherein the foveal region is defined to be a region immediately surrounding and encompassing the point of focus, and wherein the peripheral region is defined to be a region outside of the foveal region and surrounding the foveal region.

6. The method of claim 1, wherein providing the visual output includes providing the visual output with higher resolution in the foveal region and lower resolution outside of the foveal region.

7. The method of claim 6, wherein the visual output outside of the foveal region has a resolution that progressively decreases with distance from the foveal region.

8. The method of claim 1, wherein the visual cues are provided in only a portion of the peripheral region.

9. The method of claim 1, further comprising:
determining an updated point of focus at an updated location on the display;
updating the foveal region and the peripheral region relative to the updated location of the updated point of focus; and
providing an updated visual output, via the display, with the visual cues being provided in the updated peripheral region and being excluded from the updated foveal region.

10. The method of claim 9, wherein updating the foveal region and the peripheral region includes changing at least one of a size parameter, a shape parameter, or a centeredness parameter of at least one of the foveal region or the peripheral region.

11. An electronic device comprising:
a processing unit coupled to a display, the processing unit being configured to execute computer-readable instructions to cause the electronic device to:
obtain sensed data representing vehicle motion;
obtain data for determining a point of focus on the display;
define a foveal region of the display and a peripheral region of the display, the foveal region and the peripheral region being defined relative to the point of focus; and
provide a visual output, via the display, with visual cues that exhibit movement in accordance with the vehicle motion, the visual cues being provided in the peripheral region and being excluded from the foveal region.

12. The electronic device of claim 11, wherein the data for determining the point of focus is one of:
data representing a location of a detected gaze on the display, wherein the point of focus is determined to be the location of the detected gaze on the display;
data representing a salient region of an image to be outputted on the display, wherein the point of focus is determined based on a bounding box of the salient region;
data representing a location of a touch input on the display, wherein the point of focus is determined to be the location of the touch input on the display; or
data representing a location of a mouse input on the display, wherein the point of focus is determined to be the location of the mouse input on the display.

13. The electronic device of claim 12, wherein the data for determining the point of focus is data representing multiple salient regions of the image to be outputted on the display, wherein the point of focus is determined based on the bounding box of the salient region having a highest saliency score or highest saliency ranking.

14. The electronic device of claim 12, wherein the data for determining the point of focus is data representing multiple salient regions of the image to be outputted on the display, wherein respective multiple points of focus are determined based on the respective multiple bounding boxes of the respective multiple salient regions.

15. The electronic device of claim 11, wherein the foveal region is defined to be a region immediately surrounding and encompassing the point of focus, and wherein the peripheral region is defined to be a region outside of the foveal region and surrounding the foveal region.

16. The electronic device of claim 11, wherein providing the visual output includes providing the visual output with higher resolution in the foveal region and lower resolution outside of the foveal region.

17. The electronic device of claim 16, wherein the visual output outside of the foveal region has a resolution that progressively decreases with distance from the foveal region.

18. The electronic device of claim 11, wherein the instructions further cause the electronic device to:
determine an updated point of focus at an updated location on the display;
update the foveal region and the peripheral region relative to the updated location of the updated point of focus; and
provide an updated visual output, via the display, with the visual cues being provided in the updated peripheral region and being excluded from the updated foveal region.

19. The electronic device of claim 11, wherein the electronic device is one of:
a smartphone;
a laptop;
a tablet;
an in-vehicle display device;
a head mounted display device;
an augmented reality device; or
a virtual reality device.

20. A non-transitory computer-readable medium having machine-executable instructions stored thereon, the instructions, when executed by a processing unit of an electronic device, cause the electronic device to:
obtain sensed data representing vehicle motion;
obtain data for determining a point of focus on the display;
define a foveal region of the display and a peripheral region of the display, the foveal region and the peripheral region being defined relative to the point of focus; and
provide a visual output, via the display, with visual cues visual cues that exhibit movement in accordance with the vehicle motion, the visual cues being provided in the peripheral region and being excluded from the foveal region.
